(19) United States
(12) Patent Application Publication
(10) Pub. No.: US 2009/0138698 A1
(43) Pub. Date: May 28, 2009

(54) METHOD OF SEARCHING ENCRYPTED DATA USING INNER PRODUCT OPERATION AND TERMINAL AND SERVER THEREFOR

(76) Inventors: Kuyoung Chang, Daejeon-city (KR); Dowon Hong, Daejeon-city (KR); Hyunsook Cho, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/189,261

(22) Filed: Aug. 11, 2008

(30) Foreign Application Priority Data
Nov. 22, 2007 (KR) 10-2007-0119661

(51) Int. Cl. G06F 21/24

(52) U.S. Cl. 713/150

(57) ABSTRACT

The present invention relates to a method of searching data for a plurality of keywords when a user encrypts the data and stores the encrypted data in an unsecured server. The user transmits the inner product value of a search keyword set to a sever, and the server compares the received inner product value to an inner product value of a stored index set. When a document for which the two inner product values are matched with each other, the server returns the document.

### BACKGROUND OF THE INVENTION

1. Field of the Invention

The present invention relates to a method of searching encrypted data using an inner product operation, and more particularly, to a method of searching encrypted data for a plurality of keywords by using an inner product operation, thereby increasing security.

This work was supported by the IT R&D program of MIC/IITA. [2005-Y-001-03, Developments of Next Generation Security Technology]

2. Description of the Related Art

The present invention relates to a method of searching encrypted data while protecting a user's privacy when the user stores important data in a server.

The user may store a large amount of important data in an internal or external server due to the size of storage space, etc. However, if data is stored in an internal or external server, the data may be leaked due to server manager's malicious behaviors. If the data is stored in plaintext, the server manager may easily leak or illegally use the contents of the data.

In order to prevent such an invasion of privacy, methods of encrypting data and storing the encrypted data have been researched. However, it is difficult to search encrypted data by using a general searching method. For this reason, methods of searching encrypted data have been required.

A method of searching encrypted data was first proposed by Song, et al. (IEEE Security and Privacy Symposium 2000), and researches on various methods such as symmetric key cryptography and public keys cryptography have been carried out. Most methods are used to search for one keyword. In order to search for a plurality of keywords, a single-keyword searching method may be repeatedly performed. However, while searching for a plurality of keywords, a user may not want to disclose information on the individual keywords in order to protect privacy. Further, if the server is unreliable, it may be possible for the server to access to data by combining the single-keyword search results.

Another method includes storing a conjunction of a plurality of keywords in a server as a Meta key, and performing a search without disclosing the individual keywords. However, in a case of combining m keywords, the maximum number of necessary Meta keys is 2^{m}. For this reason, as the number of keywords increases, the number of Meta keys increases exponentially.

Furthermore, a method of searching for multiple keywords on the basis of pairing has been proposed by Golle, et al. (ACNS 2004). However, this method has some problems in that it is an inefficient, which imposes limitations from a practical application standpoint.

### SUMMARY OF THE INVENTION

Accordingly, it is an object of the present invention to provide a searching method which is capable to rapidly and securely search encrypted data stored in an unreliable server for multiple keywords while meeting both security and efficiency.

According to an aspect of the present invention, there is provided a method of searching encrypted data using an inner product operation. This method includes: generating a private key; encrypting a plurality of documents using the private key; generating index keyword values by converting a plurality of keywords in the plurality of documents into numerical values using the private key; transmitting the encrypted documents and a set of the generated index keyword values to a server so as to be stored; receiving at least one keyword for search data; generating a search keyword value by converting each of the received keywords into a numerical value using the private key; performing an inner product operation on a set of the search keyword values to generate search information; and transmitting the search information to a server.

In the generating of the index keyword values, the index keyword values may be generated using a hash function. Further, in the generating of the search keyword values, the search keyword values may be generated using the hash function.

The generating of the search information may include: generating a set of random values; and calculating the inner product of the generated random value set and the search keyword value set to generate the search information. In the transmitting of the search information, the random value set may also be transmitted to the server as the search information.

Each of a plurality of keywords may include a keyword field value representing the location of the corresponding keyword. In the transmitting of the search information, the keyword field value corresponding to each of the received keywords may also be transmitted as the search information.

According to another aspect of the invention, a terminal for searching encrypted data includes: a keyword input unit that receives at least one search keyword with respect to data to be searched; a keyword value generating unit that generates at least one search keyword value by converting each of the received keywords into a numerical value; an inner product operating unit that performs an inner product operation on a set of the search keyword values; and a search information transmitting unit that transmits to a server the inner product value as search information.

The keyword value generating unit may generate the search keyword values using a hash function.

The inner product operating unit may generate a set of random values and perform the inner product operation on the generated random value set and the search keyword value set. The search information transmitting unit may transmit to the server the random value set as the search information.

Each of the received keywords may include a keyword field value representing the location of the corresponding keyword, and the search information transmitting unit may transmit the keyword field value corresponding to each of the received keywords as the search information.

According to still another aspect of the invention, a server for searching encrypted data includes: an encrypted data storage unit that stores encrypted documents and numerical index keyword values; an inner product operating unit that performs an inner product operation using search information transmitted from a terminal and the stored index keyword values; and a comparing unit that compares the obtained inner product value with an inner product value included in the search information. The inner product operating unit performs an inner product operation for each of the stored documents, and the comparing unit compares the inner product result of each of the stored documents with the inner product value included in the search information to determine whether two inner product values are matched with each other.

The search information may include a random value set, and the inner product operating unit may perform an inner product operation on the random value set and the stored index keyword values.

The search information may include at least one keyword field value representing the location of the keyword, and the inner product operating unit may perform an inner product operation on index keyword values corresponding to the keyword field values.

### BRIEF DESCRIPTION OF THE DRAWINGS

FIG. 1 is a diagram illustrating a system for searching encrypted data according to an embodiment of the present invention;

FIG. 2 is a flowchart illustrating a method of generating encrypted data and searching the encrypted data for multiple keywords in a terminal according to an embodiment of the present invention;

FIG. 3 is a flowchart illustrating a method of searching encrypted data in a server according to an embodiment of the present invention; and

FIG. 4 is a diagram illustrating an example of keyword fields associated with each documents according to an embodiment of the present invention.

### DESCRIPTION OF THE PREFERRED EMBODIMENTS

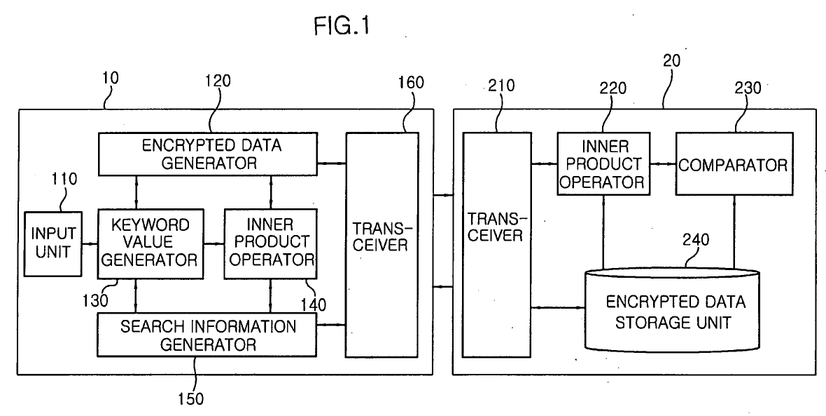

First, a system for searching encrypted data according to an embodiment of the present invention will be described with reference to FIG. 1.

A system according to an embodiment of the present invention includes a terminal 10 and a server 20.

The terminal 10 includes an input unit 110 that receives data to be encrypted or at least one search keyword, an encrypted data generator 120 that encrypts data, a search information generator 150 that generates search information to be transmitted to a server, a keyword value generator 130 and an inner product operator 140 that perform operations for generating encrypted data or search information, and a transceiver 160 that transmits the information.

The server 20 includes a transceiver 210 that receives encrypted data or search information from the terminal 10, an encrypted data storage unit 240 that stores encrypted data or related information, and an inner product operator 220 and a comparator 230 that perform operations based on search information in order to search for desired documents.

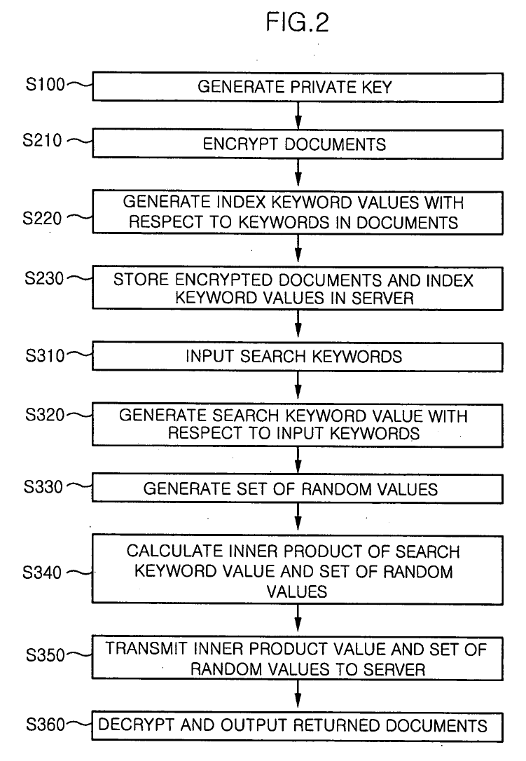

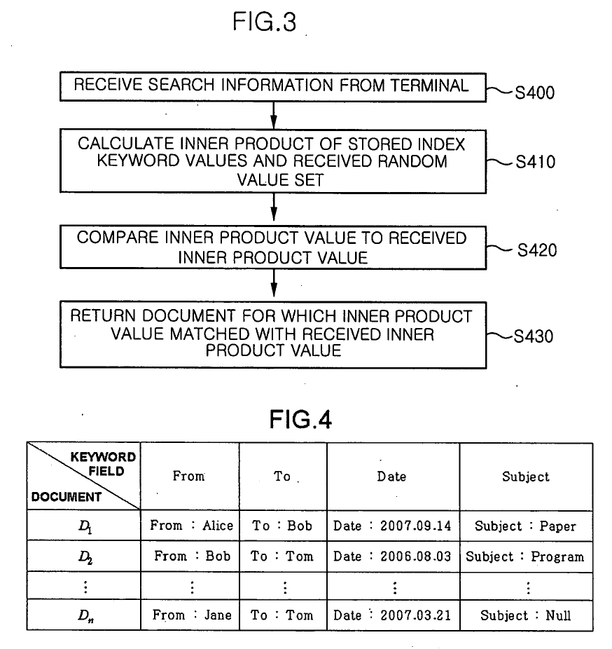

A method of searching encrypted data according to an embodiment of the present invention will be described with reference to FIGS. 2 and 3.

FIG. 2 is a flowchart illustrating a method of searching encrypted data in the terminal 10, and FIG. 3 is a flowchart illustrating a method of searching encrypted data in a server 20.

The searching method in the terminal 10 generally includes generating a private key (S100), encrypting a plurality of documents (S210), generating an index of keywords in the individual documents (S220), transmitting the encrypted documents and the index to the server (S230), and receiving search keywords and transmitting search information to the server (S310 to S350). The searching method used in the server 20 includes comparing the search information transmitted from the terminal 10 to a stored index to extract documents matched to the search information and returning the matched documents (S400 to S430).

First, the general environment in which the present invention is applied will be described. Hereinafter, a user means a user's terminal 20.

It is assumed that a user encrypts important data and stores the encrypted data in an unsecured server. It is assumed that the total number of documents is n. The n documents are denoted by D₁ to Dₙ. Furthermore, it is assumed that the number of keyword fields with respect to each document is m. For example, if data is an email, four keyword fields, such as a “From” field, a “To” field, a “Date” field, and a “Subject” field, may be assumed. Keywords are assigned to corresponding fields. For the security of the scheme, it is assumed that the same word cannot appear in any two different keyword fields. As shown in FIG. 4, if “From: Alice”, “To: Bob”, “Date: 2007.09.14”, and “Subject: Paper” are assigned to the “From” field, the “To” field, the “Date” field, and the “Subject” field, respectively, the same word does not appear in any two different keyword fields. Further, if there is no keyword in a corresponding keyword field, for example, if there is not keyword corresponding to the “Subject” field, a keyword, for example, “Subject: Null” may be assigned.

Assuming the above-mentioned environment, a searching method according to an embodiment of the present invention will be described with reference to FIGS. 2 and 3.

Now, a process in which the encrypted data generator 120 encrypts a plurality of documents and a plurality of keywords in the documents and stores an index will be described.

First, a user randomly generates a private key K for encrypting data and a keyword set for data searching (S100). The private key K should be a secret that no one knows other than the user. The length of the private key is determined according to an encrypting algorithm.

It is assumed that the user has n documents D₁, D₂, Dₙ, m keyword fields exist in each of the documents, and keywords with respect to a document Dᵢ are denoted by Wᵢ₁, Wᵢ₂, . . . , Wᵢₘ. In other words, Wᵢⱼ means a keyword corresponding to a j-th keyword field with respect to the document Dᵢ.

After the user randomly selects k₁, k₂, . . . , kₘ in GF(p), these values are kept secret. Here, it is preferable that p be a prime number. Further, since the size of p relates to the security of the scheme, it is preferable to set the size of p to be equal to the length of the private key K. In consideration of the security of a current encrypting algorithm and computing power, it is preferable to set the size of p to 120 bits or more. Similar to the private key K, the private information should be a secret that no one knows other than the user.

The user encrypts the individual documents Dᵢ using the private key K to generate encrypted documents E_{K}(Dᵢ) (S210). Here, E_{K}( ) is a symmetric key encryption algorithm, in which K is a private key. Further, the user calculates vectors (h_{K}(W_{i1⊕1}), hₖ(W_{i1⊕2})), (hₖ(Wᵢ₂⊕1), hₖ(Wᵢ₂⊕2)), . . . , (hₖ(Wᵢₘ⊕1), hₖ(Wᵢₘ⊕2)) (where hₖ)) is a keyed hash function, in which K is a private key). In order to simplify those symbols, (hₖ(Wᵢⱼ⊕1), hₖ(Wᵢⱼ⊕2)) is defined as Hᵢⱼ. Next, the user selects a random value aᵢ from GF(p). The value aᵢ should be kept secret and the user does not need to know or store the value aᵢ. Finally, the user randomly generates a public vector Gᵢ=(gᵢ₁,gᵢ₂). Using those generated values, the user generates the following values with respect to each document Dᵢ (S220)

Gᵢ, <Hᵢ₁,Gᵢ>+k₁aᵢ, <Hᵢ₂,Gᵢ>+k₂aᵢ, . . . , <Hᵢₘ,Gᵢ>+kₘaᵢ, E_{K}(Dᵢ) [Expression 1]

The calculation of Expression 1 is performed in GF(p). Here, <Hᵢⱼ,Gᵢ>+kⱼaᵢ is a numerical value which a keyword corresponding to the j-th keyword field of each document Dᵢ is converted into and is referred to as an index keyword value. <Hᵢⱼ,Gᵢ> means the inner product of Hᵢⱼ and Gᵢ. For example, the inner product of a vector (a,b) and a vector (c,d) (that is, <(a,b),(c,d)>) is ac+bd. The user performs the above-mentioned operation on all of the documents D₁, D₂, . . . , Dₙ, and this operation is performed by the keyword value generator 130 and the inner product operator 140.

The public vectors Gᵢ, the index keyword values <Hᵢⱼ,Gᵢ>+kⱼaᵢ with respect to the individual keywords, and the encrypted documents E_{K}(Dᵢ) generated by the above-mentioned method are stored in the form of Expression 2 in the server through the transceiver 160:

G₁, <H₁₁,G₁>+k₁a₁, <H₁₂,G₁>+k₂a₁, . . . , <H₁ₘ,G₁>+kₘa₁, E_{K}(D₁)

G₂, <H₂₁,G₂>+k₂a₂, <H₂₂,G₂>+k₂a₂, . . . , <H₂ₘ,G₂>+kₘa₂, E_{K}(D₂)

[symbol]

Gₙ, <Hₙ₁,Gₙ>+k₁aₙ, <Hₙ₂,Gₙ>+k₂aₙ, . . . , <Hₙₘ,Gₙ>+kₘaₙ, E_{K}(Dₙ). [Expression 2]

The server 20 stores the individual Expression 2 in a database 240 corresponding to the user.

Next, a process in which the user inputs at least one keyword and searches for desired data will be described. When the user wants to search for documents including a plurality of keywords, in general, a conjunction of the keyword search results is used to search for corresponding documents. In order to keep the individual keywords concealed from the server 20, the keyword transmitted to the server should be encrypted and it is preferable that the keywords can not be divided into individual keywords. Therefore, even when a plurality of keywords are searched, the individual keywords need to be capsulated without being divided, and transmitted to the server 20.

Returning to the data searching method according to the embodiment of the present invention, if at least one search keyword is input through the input unit 110 of the terminal 10 (S310), first, the location of each keyword field and a corresponding keyword value are extracted. When t search keywords are input, pairs of the locations of keyword fields to be searched and keyword values are denoted by (i(1),Wᵢ₍₁₎) , (i(2),Wᵢ₍₂₎), . . . , (i(t),Wᵢ₍ₜ₎). For example, with respect to a plurality of documents as shown in FIG. 4, if the user wants to search for a document in which the transmitter is “From: Bob” and the date is “Data: 2006.08.03”, the locations of the corresponding keyword fields and the corresponding keyword values are (1, “From: Bob”) and (3, “Data: 2006.08.03”). The keyword value generator 130 calculates the following values using the private key K:

H₁=(h_{K}(Wᵢ₍₁₎⊕1), h_{K}(Wᵢ₍₁₎⊕2), H₂=(h_{K}(Wᵢ₍₂₎⊕1), h_{K}(Wᵢ₍₂₎⊕2)), . . . , Hₜ=(h_{K}(Wᵢ₍ₜ₎⊕1) h_{K}(Wᵢ₍ₜ₎⊕2)).

The obtained values H₁ to Hₜ are defined as search keyword values.

Next, the user randomly selects a set of arbitrary random values s₁, s₂, . . . , sₜ₋₁ in GF(p), and the inner product operator 140 calculates a numerical value sₜ meeting Expression 3 (S330):

s₁kᵢ₍₁₎+s₂kᵢ₍₂₎+ . . . +sₜ₋₁kᵢ₍ₜ₋₁₎+sₜkᵢ₍ₜ₎=0. [Expression 3]

An inner product operation is performed on the search keyword values and the random value set generated in the above-mentioned method to obtain a value of s₁H₁+s₂H₂+ . . . +sₜ₋₁Hₜ₋₁+sₜhₜ(S340). Next, the obtained value, the locations of the keyword fields (i(1), i(2), . . . , i(t)), and the set of arbitrary random values s₁, s₂, . . . , sₜ₋₁ are transmitted to the server 20 through the transceiver 160 (S350). The server 20 searches the encrypted documents using the transmitted data and the stored values of Expression 2.

The server 20 performs the following processes in order to determine whether a document E_{K}(Dᵢ) is a desired document. First, the inner product operator 220 calculates an inner product <s₁H₁+s₂H₂+ . . . +sₜ₋₁Hₜ₋₁+sₜHₜ,Gⱼ> using the transmitted value s₁H₁+s₂H₂+ . . . +sₜ₋₁Hₜ₋₁+sₜHₜ and Gⱼ stored in the server. The server 20 performs an inner product operation on elements (i(1), i(2), . . . , i(t)) representing the locations of the keyword fields, the set of arbitrary random values s₁, s₂, . . . , sₜ₋₁, sₜ and the index keyword values stored in the server 20 to calculate s₁(<Hⱼᵢ₍₁₎,Gⱼ>+Kᵢ₍₁₎aⱼ)+s₂(<Hⱼᵢ₍₂₎,Gⱼ>+Kᵢ₍₂₎aⱼ)+ . . . +sₜ(<Hⱼᵢ₍ₜ₎,Gⱼ>+Kᵢ₍ₜ₎aⱼ) (S410).

Next, the comparator 230 calculates the difference between the two calculated values, that is, <s₁H₁+s₂H₂+ . . . +sₜ₋₁Hₜ₋₁+sₜHₜ,Gⱼ>−{s₁(<Hⱼᵢ₍₁₎,Gⱼ>+Kᵢ₍₁₎aⱼ)+s₂(<Hⱼᵢ₍₂₎,Gⱼ>+Kᵢ₍₂₎aⱼ)+ . . . +sₜ(<Hⱼᵢ₍ₜ₎,Gⱼ>+Kᵢ₍ₜ₎aⱼ)} (S420). If the transmitted search keyword is matched with the keyword included in the document Dᵢ stored in the server, the difference between the two values, that is, <s₁H₁+s₂H₂+ . . . +sₜ₋₁Hₜ₋₁+sₜHₜ,Gⱼ>−{s₁(<Hⱼᵢ₍₁₎,Gⱼ>+Kᵢ₍₁₎aⱼ)+s₂(<Hⱼᵢ₍₂₎,Gⱼ>+Kᵢ₍₂₎aⱼ)+ . . . +sₜ(<Hⱼᵢ₍ₜ₎,Gⱼ>+Kᵢ₍ₜ₎aⱼ)} becomes −aⱼ(s₁kᵢ₍₁₎+s₂kᵢ₍₂₎+ . . . +sₜkᵢ₍ₜ₎), which becomes 0 by Expression 3.

The comparator 230 performs the above-mentioned process on all of E_{K}(Dᵢ) of Expression 2, searches for encrypted documents for which the result of the above-mentioned process is 0, and transmits the searched encrypted documents to the terminal 10 through the transceiver 210 (S430).

Finally, the user decrypts the encrypted document in the terminal 10 using the private key K (S360) and thus the corresponding documents become accessible.

As described above, the method of searching encrypted data for multiple keywords, in which the server does not know the contents of the data and the contents of the index, is provided. Therefore, it is possible to protect the privacy of the user, to search for a plurality of keywords at the same time, and to prevent information on each keyword from leaking out to the server.

Further, in order to search for t keywords, the server needs to perform a one inner product operation, t finite field multiplications, and t finite field additions for each document. An inner product operation needs to perform 2 finite field multiplications and a one finite field addition. Therefore, in order to search for t keywords, totally, (t+2) finite field multiplication operations and (t+1) finite field addition operations are required. The computational complexity is less than that of the existing method which requires several times of pairing operations with respect to individual documents when multiple keywords are searched for. Therefore, it is possible to improve the efficiency.

According to the method of searching encrypted data using an inner product operation, it is possible to search for data desired by the user while keeping the contents of data and keywords concealed from the server. Therefore, it is possible to protect the privacy of the user with respect to important data.

Further, it is possible to search for a plurality of keywords at the same time, and to prevent the server from accessing user's data by keeping information on the keywords concealed from the server.

Furthermore, it is possible to search for multiple keywords using less amounts of calculation as compared to the existing method based on a pairing operation, thereby improving the search efficiency.

Although the method of searching for multiple keywords according to a representative embodiment of the present invention has been described, it will be appreciated that modifications and variations can be made in the present invention without deviating from the spirit or scope of the invention in which the results calculated by an inner product operation are transmitted to the server and documents matched to the results are searched for. A process of generating a public vector or a set of random values may be performed in other ways, and the document encryption and the index generation are not limited to the above-mentioned embodiment. Further, as long as encryption is performed in a numerical value form as well as a hash function in the process of converting keywords into numerical values, other methods can be performed.

Further, according to the above-mentioned method, it is assumed that a plurality of keywords have fixed keyword field values. However, as long as a keyword set is maintained in a form on which an inner product operation can be performed, the field values for individual documents may vary.

Furthermore, according to the searching system according to the embodiment of the present invention, each component may include other components. For example, the encrypted data generator or the search information generator may include the transceiver.

What is claimed is:

1. A method of searching encrypted data using an inner product operation in a terminal, the method comprising:
receiving at least one keyword with respect to data to be searched;
generating at least one search keyword value by converting each of the keywords into a numerical value;
generating search information by performing an inner product operation on a set of the keyword values; and
transmitting the search information to a server.

2. The method of claim 1,
wherein, in the generating of the search keyword values, the search keyword values are generated by a hash function.

3. The method of claim 1,
wherein the generating of the search information includes:
generating a set of random values; and
calculating the inner product of the generated random value set and the search keyword value set to generate the search information, and
in the transmitting of the search information, the random value set is also transmitted to the server as the search information.

4. The method of claim 1,
wherein each of the received keywords includes a keyword field value representing the location of the corresponding keyword, and
in the transmitting of the search information, the keyword field value corresponding to each of the received keywords is also transmitted as the search information.

5. A terminal for searching encrypted data, the terminal comprising:
a keyword input unit that receives at least one search keyword with respect to data to be searched;
a keyword value generating unit that generates at least one search keyword value by converting each of the received keywords into a numerical value;
an inner product operating unit that performs an inner product operation on a set of the search keyword values; and
a search information transmitting unit that transmits to a server the inner product value as search information.

6. The terminal of claim 5,
wherein the keyword value generating unit generates the search keyword values using a hash function.

7. The terminal of claim 5,
wherein the inner product operating unit generates a set of random values and performs the inner product operation on the generated random value set and the search keyword value set, and
the search information transmitting unit transmits to the server the random value set as the search information.

8. The terminal of claim 5,
wherein each of the received keywords includes a keyword field value representing the location of the corresponding keyword, and
the search information transmitting unit transmits the keyword field value corresponding to each of the received keywords as the search information.

9. A server for searching encrypted data, the server comprising:
an encrypted data storage unit that stores encrypted documents and numerical index keyword values;
an inner product operating unit that performs an inner product operation using search information transmitted from a terminal and the stored index keyword values; and
a comparing unit that compares the obtained inner product value with an inner product value included in the search information,
wherein the inner product operating unit performs an inner product operation for each of the stored documents, and
the comparing unit compares the inner product result of each of the stored documents with the inner product value included in the search information to determine whether two inner product values are matched with each other.

10. The server of claim 9,
wherein the search information includes a random value set, and
the inner product operating unit performs an inner product operation on the random value set and the stored index keyword values.

11. The server of claim 9,
wherein the search information includes at least one keyword field value representing the location of the keyword, and
the inner product operating unit performs an inner product operation index keyword values corresponding to the keyword field values.
